(19) United States
(12) Patent Application Publication
(10) Pub. No.: US 2006/0179693 A1
(43) Pub. Date: Aug. 17, 2006

(54) Device providing simultaneous visibility of images within the area of 360 around itself

(76) Inventor: Jan Babic, Idrija (SI)

Correspondence Address: JACOBSON HOLMAN PLLC, 400 SEVENTH STREET N.W., SUITE 600, WASHINGTON, DC, 20004, US

(21) Appl. No.: 10/533,382

(22) PCT Filed: Nov. 7, 2003
(86) PCT No.: PCT/SI03/00040

§ 371 Date: Apr. 29, 2005

(30) Foreign Application Priority Data
Nov. 8, 2002 (SI) P-200200268
Nov. 6, 2003 (SI) P-200300271

(51) Int. Cl. G09D 3/02

(52) U.S. Cl. 40/122

(57) ABSTRACT

A device providing simultaneous visibility of image in the area of 360° around it is conceived in a way to allow visibility of images and simultaneously also allow changing of images during uninterrupted operation and by rendering a not distorted image regardless of the distance of the watching point from the image in the area of 360° around the device. The device of the invention is made of a shield (1), preferably a cylindrical one, which rotates around its axle (2) with an optional drive (3), whereby the shield (1) has a coating with a slot (4) running approximately parallel to the axle (2), whereby the shield (1) has at least one display (5) on the diametral surface or near it, with controlled light points, e.g. liquid crystals (LCD) or light-emitting diodes. The essence of the invention is that there is foreseen a microprocessor controller (9) between a processor (6) and the display (5), said controller adjusting location of each point of image, intended to be seen by the spectator, to a new location on the display (5), depending on the distance of a spectator's eye from the display (5), angle of the display (5) with respect to the line (10) of view and each distance between the slot (4) and the observed point (12) on the display (5).

### SUBJECT OF INVENTION

The subject of the invention is a device providing simultaneous visibility of images within the area of 360° around itself, whereby the image can be any static or changing graphical or alphanumerical image or even an image of a 3-D object.

### TECHNICAL PROBLEM

The technical problem solved by the present invention is how to conceive a device possessing the mentioned characteristics that would provide visibility of images as above and simultaneously also allow changing of images during uninterrupted operation and by rendering a not distorted image regardless of the distance of the watching point from the image in the area of 360° around the device.

### PRIOR ART

An invention of this type is known from the Slovene patent SI 9300366 (Judjav\check{c}i\check{c}), a drawback of which is that it does not solve the distortion of the image observed by a spectator, said distortion being due to the fast rotation of the opaque cylinder, moreover, the spectation field is limited due to orientation of lamellas into a common point, defining a radius of the circle, on which a spectator may be in order to see an optimal image. Stepping away from the trajectory towards or from its centre causes a linear increase of narrowing of parts of the image in direction to its side edges.

Furthermore the invention is known from the Slovene patent SI 9800044 (Juijav\check{c}i\check{c}), which tries to solve the described unsolved problem of the above invention by using a concave cylinder and by changing the lamellas with a slot running parallel to the axis and positioned between the cylinder and the spectator as well as moving simultaneously with the cylinder and the image presented on it. The invention solves a mechanical concept for the operation of said device, however, as far as a distorted image is concerned, it only provides an “adequate shape” of the image or object to be viewed in the device by a spectator.

The described device of the invention calls for two corrections: the first one concerns watching of each viewed part of an image or object, which must lie in the horizontal level lying vertically to the line of view if we want to avoid distorted dimensions, and the second one concerns rotation of the image in the device, which results in a changing distance of parts of the image from the spectator, i.e. slanted position of the image with respect to the spectator, which causes distortion due to perspective.

Both mentioned types of distortion cannot be simultaneously solved in a mechanical way, because the first one needs a concave cylinder with the centre in the slot, whereas the second one needs a concave cylinder along the curve, which allows for the distance of a spectator and at the same time rotation of the cylinder by assuring that in each point of rotation the part of the currently visible image lies vertically to the line of view.

A failure to comply with the second condition is less noticeable or it can be disregarded, if the width of the image is smaller than the diameter of the display (cylinder) with a slot, so that it only occupies the central part of the diameter. This causes discrepancy between the width of the device and the width of the presented image, which is not spectator friendly.

A further characteristic of this invention lies in the absence of a correction solution to the mentioned mechanically excluding conditions to assure a clear image provided by the device. The description of the invention points at this problem, yet does not solve it.

The goal of the invention is therefore a solution to this problem by allowing for technical and especially financial frameworks of technological capabilities of manufacturing of such device to be acceptable on the market.

### Solution to the Technical Problem

The described technical problem is solved by the device of the invention, which preserves the concept of a rotating cylinder, preferably a cylinder coating with a slot running parallel to the axis of the cylinder, around which it revolves. An essential novelty is a display or a board consisting of a plurality of luminous points controlled by a microprocessor in order to get a desired image. The microprocessor contains a unit positioned between the output for control of individual points and the display, whereby said unit adjusts the position of each point to a new position on the display, so that during the rotation of the display the spectator watches the original image, whereby the mentioned unit continuously extends said position from the centre towards both side edges as a function of the current edge of the display with respect to the line of view, i.e. a visible line running from the spectator's eye through the slot on the cylinder, whereby the slot moves with the rotation of the cylinder to the point on the display and simultaneously corrects each point also due to the slanted position of the display with respect to the point of view in the sense of nullification of the perspective, which appears due to the spectator's distance from the display. If both conditions are met, visibility of a correct or rather desired image is continuously assured from all sides simultaneously.

Since the device of the invention has a display with an electronic controller, it is possible to show static and moving images or several images due to the speed of its control with respect to a possibility of a human eye to follow merged images of at least 14 or more images per second. This was also pointed at in the patent SI 9800044, yet remained technically unsolved.

the display may be an optional flat display within the known prior art, e.g. a liquid crystal display (LCD) for small devices, e.g. used in rooms or on tables, or a light-emitting diode display for larger devices, on which images are visible from a greater distance, preferably outside.

This solution also solves the problem of a use, when the spectators are positioned around the device at various distances, for instance if the device is located in the centre of an oblong table. The controlling part of the microprocessor in the field of each revolution allows for various distances of spectators. Even a large device with light-emitting diodes positioned before tribunes at different distances from it offers the same correction possibility.

In the embodiment of the device for static images and images exceeding computer or television set displays, an optional concave display can be used, whereby a transformed image is positioned on the display. Individual points of the image, we want the spectators to see via the device of the invention, are transferred to new locations, whereas both computerized corrections are taken into consideration and then the transformed image is made following a printing or any other known procedure.

In order that the present invention be more readily understood, an embodiment thereof will now be described by way of example with reference to the accompanying drawing in which:

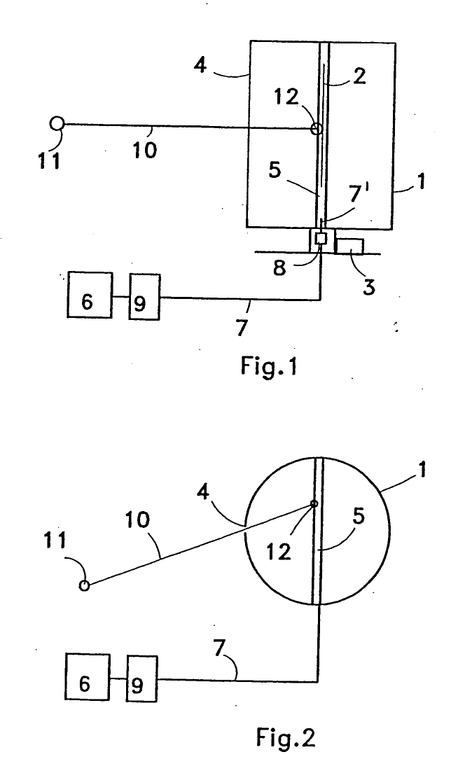

FIG. 1 shows a plan view of the device of the invention;

FIG. 2 shows a ground plan of the device of the invention;

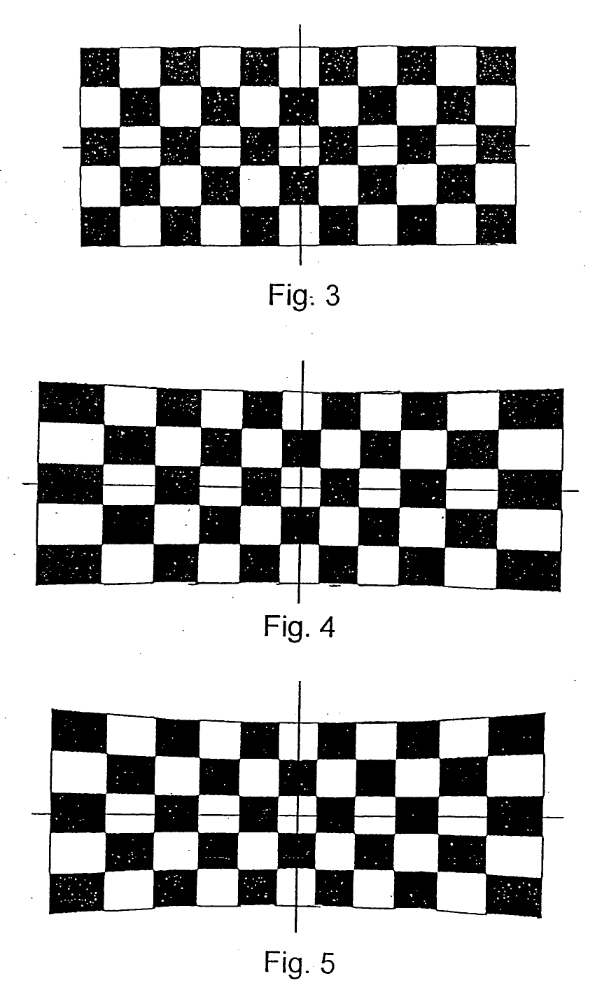

FIG. 3 shows an image intended to be seen by the spectator;

FIG. 4 shows a corrected image on the display providing visibility from a great distance, so that the spectator sees the image from FIG. 3, and

FIG. 5 shows a corrected image on the display providing visibility from a smaller distance, so that the spectator sees the image from FIG. 3.

A device allowing simultaneous visibility of images in the area of 360° around it, is made of a shield 1, preferably a cylindrical one, which rotates around its axle 2 with an optional drive 3, whereby the shield has a coating with a slot 4 running parallel to the axle 2, whereby the shield 1 has at least one display 5 on the diametral surface or near it, whereby this display is an optional display with controlled light points, e.g. liquid crystals (LCD) or light-emitting diodes, and which renders it possible to show static or changing images and rotates simultaneously with the shield. The position of the display 5 in the shield 1 is such to allow the slot 4 to lie vertically to the surface of the display.

Control of light-emitting points of the display 5 is driven by a microprocessor 6 in a known way, e.g. with a usual personal computer and a known program via a wire 7, preferably an optical line, entering the shield through the axle 2, whereby the shield 1 has a light sensor 8 enabling transmission of a signal from the static wire 7 to the rotating extension 7′ of the wire 7.

Between the processor 6 and the display 5 there should be a microprocessor controller 9, which adjusts the location of each image point to be seen by a spectator to a new location on the display 5, by moving its vertical coordinate running parallel to the axle 2 to the edge of the image as a function of each length of a line 10 of view, i.e. the line length running from the eye 11 of the spectator through the slot 4 on the shield 1 up to a point 12 on the display 5, whereby it allows—also due to the rotation of the shield 1—for a changing length of one part of the line 10 of view through the slot 4 to the point 12 on the display 5, and also the distance of the eye 11 from the shield 1, changing within the angle of 360° with the centre in the axle 2, whereby this correction diminishes by the increase of each line 10 of view and increases by the distance of each point 12 from the centre of the display 5, and

by moving a horizontal coordinate running vertically to the axle 2 to its nearby lying edge of the display 5 running parallel to the axle 2 with respect to the length of the line 10 of view, the distance of the slot 4 from the display and the distance of each point 12 from the central line of the display 5, allowing for each angle of the display 5 with respect to the line 10 of view.

The smaller the distance of watching, the smaller the horizontal correction of each point 12.

The described image correction can also be written down mathematically by using the basic geometrical laws or a computer algorithm can be developed, the transformer of which in real time adequately transforms the image, therewith allowing presentation of static and moving images of an optional arrangement with the device of the invention.

The device should preferably contain two displays 5, positioned in the vicinity of the diametral surface of the shield 1 and leaning one to another with their rear parts.

To show static images it is not necessary to use a LCD display used in the invention, an optional concave display with a transformed image can be used, made in a way that individual points of the image we want to be seen by the spectators via the device of the invention are transferred to new locations taking both corrections into account.

The transformed image for the embodiment can be obtained by correcting a digital variant of an image we want to show to spectators—said image being obtained by scanning or creating a new digital image using an optional computer program—by a computer as shown above and then by transferring the transformed image to a material carrier by means of printing or in any other known way. The image transformed physically in this way is used on the display in the device instead of a LCD display. This embodiment also allows arrangement of several displays with images in the device.

It is understandable that the structure of the device can be very variegated, especially in the sense of industrial design and with respect to various purposes without circumventing the essence of the invention defined in the attached patent claims.

1. A device allowing simultaneous visibility of images in the area of 360° around it, is made of a shield (1), preferably a cylindrical one, which rotates around its axle (2) with an optional drive (3), whereby the shield (1) has a coating with a slot (4) running approximately parallel to the axle (2), whereby the shield (1) has at least one display (5) on the diametral surface or near it, whereby this display is an optional display with controlled light points, e.g. liquid crystals (LCD) or light-emitting diodes, and which renders it possible to show static or changing images and rotates simultaneously with the shield, whereby control of light-emitting points (12) of the display (5) is driven by a microprocessor (6) via a wire (7), preferably an optical line, entering the shield through the axle (2), whereby the shield (I) has a light sensor (8) enabling transmission of a signal from the static wire (7) to the rotating extension (7′) of the wire (7), characterized in that between the processor (6) and the display (5) there should be a microprocessor controller (9), which adjusts the location of each image point to be seen by a spectator to a new location on the display (5),
by moving its vertical coordinate running parallel to the axle (2) to the edge of the image as a function of each length of a line (10) of view, i.e. the line length running from the eye (11) of the spectator through the slot (4) on the shield (1) up to a point (12) on the display (5), whereby it allows—also due to the rotation of the shield (1)—for a changing length of one part of the line (10) of view through the slot (4) to the point (12) on the display (5), and also the distance of the eye (11) from the shield (1), optionally hanging within the angle of 360° with the centre in the axle (2), whereby this correction diminishes by the increase of each line (10) of view and increases by the distance of each point (12) from the centre of the display (5), and
by moving a horizontal coordinate running perpendicularly to the axle (2) to its nearby lying edge of the display (5) running parallel to the axle (2) with respect to the length of the line (10) of view, the distance of the slot (4) from the display (5) and the distance of each point (12) from the central line of the display (5), allowing for each angle of the display (5) with respect to the line (10) of view.

2. A device according to claim 1, characterized in that a LCD display as a carrier of the image we want to show to the spectators is replaced by an optional concave display showing a static image, which is a transformed image of the image, foreseen to be seen by the spectators, whereby said transformed image can be obtained by correcting a digital variant of an image we want to show to spectators—said image being obtained by scanning or creating a new digital image using an optional computer program—as shown in claim 1 and then by transferring the transformed image to a material carrier by means of printing or in any other known way and by using this image in the device of the present invention as a replacement for a LCD display.
